(19) United States
(12) Patent Application Publication
(10) Pub. No.: US 2025/0054315 A1
(43) Pub. Date: Feb. 13, 2025

(54) 2-D REAL-TIME PEDESTRIAN POSE ESTIMATION MODEL FOR AUTONOMOUS DRIVING SYSTEMS

(71) Applicant: Black Sesame Technologies Inc., San Jose, CA (US)

(72) Inventors: Xiaomin Liu, San Jose, CA (US); Wenyi Wang, San Jose, CA (US); Lei Zhang, San Jose, CA (US); Qun Gu, San Jose, CA (US)

(21) Appl. No.: 18/232,602

(22) Filed: Aug. 10, 2023

(51) Int. Cl. G06V 20/58; G06T 7/246; G06T 7/73; G06V 10/82; G06V 40/10; G06V 40/20

(52) U.S. Cl. CPC G06V 20/58; G06T 7/251; G06T 7/75; G06V 10/82; G06V 40/10; G06V 40/20; G06T 2207/20024; G06T 2207/20081; G06T 2207/20084; G06T 2207/30196; G06T 2207/30252

(57) ABSTRACT

The present invention discloses a system for detecting poses of people around a vehicle. An electronic sensor such as a camera is associated with a vehicle for the generation of consecutive frames within a video. The system generates a boundary box around a person within each frame and optimizes a tracker for each person in consecutive frames. The system detects people on the road through pose estimation. The system performs a confidence pre-processing procedure before sending the trackers to a pose estimator to extract their poses.

### FIELD OF THE INVENTION

The present invention relates to the real-time detection of vulnerable people such as pedestrians, cyclists, skaters and the like, for safer and efficient advanced driver assistance systems (ADAS). More particularly, the present invention relates to pose estimation of people using video capturing capabilities of driving systems within a vehicle to avoid collision.

### BACKGROUND OF THE INVENTION

In advanced driving systems or autonomous driving systems of self-driving vehicles it is crucial to ensure passenger safety by skillful and timely maneuvering of the vehicle while still abiding traffic laws and regulation, such as lane keeping, turning, stopping at signal, pedestrian crossings etc. Pedestrian pose estimation is an essential step in perception technology of assisted/autonomous driving, which comprises predicting and associating human body parts or keypoints of pedestrians. Pose estimation provides an effective low dimensional and interpretable representation of human bodies, which is critical for recognizing the actions and predicting the behaviors of vulnerable road users (VRUs), such as pedestrians and cyclists. It is important to detect critical actions (e.g., pedestrians crossing the street or cyclists signaling to turn left/right) of VRUs accurately and timely, to avoid any collisions and ensure the safety and comfort of all road users. Pedestrian pose estimation is particularly challenging because of the restricted scales of pedestrians in images with a large FOV. In addition, human body occlusions are frequently observed in crowd scenes, or in scenes where pedestrians walk side by side or cross each other.

Unlike passenger safety, ensuring the safety of people is also important for new age driving systems. ADAS are using various approaches to firstly identify people vulnerable to injury or collision with a vehicle and then maneuvers the vehicle accordingly away for safety. Perception technology used within ADAS involves detection of keypoints that are associated with body parts or limbs of people. Predicting actions of people becomes difficult when factoring in situations in which the roadside is crowded, or the pedestrians or cyclists are traveling in-front or beside each other from the point-of-view of the vehicle. ADAS associated with the vehicle is hence posed with curious challenge and may detect multiple people erroneously. In addition to crowds, whereby multiple people are occluded from detection, false negatives may also arise due to “small” or “faraway” people.

Various deep learning approaches for such perception technology can be grouped into two general approaches: top-down or bottom-up. Zhe Cao et al. in “Realtime Multi-Person 2D Pose Estimation using Part Affinity Fields” uses Part Affinity Fields (PAFs) to learn how to associate body parts with individuals in images. A greedy bottom-up parsing step maintains high accuracy while achieving real-time detection, irrespective of the number of people in an image.

A similar bottom-up approach is found in “PersonLab: Person Pose Estimation and Instance Segmentation with a Bottom-Up, Part-Based, Geometric Embedding Model” by George Papandreou et al. The model explained uses both semantic-level reasoning and object-part associations using part-based modeling. This system learns to detect individual keypoints and predict their relative displacements, so as to re-group keypoints into person pose instances.

A deep learning top-down approach is explained in “Stacked hourglass networks for human pose estimation” by Newell et al. The article describes an architecture as a “stacked hourglass” network based on the successive steps of pooling and up-sampling that are done to produce a final set of predictions. Features are processed across all scales and consolidated to best capture the various spatial relationships using novel convolutional network architecture for the task of pose estimation of the people. However, repeated bottom-up, top-down processing used in conjunction with intermediate supervision is critical to improving the performance of the network.

The research titled “Simple baselines for human pose estimation and tracking” by Xiao et al. discloses simple and effective baseline methods including simple algorithms and architecture for pose estimation. In both of the previous approaches, the top-down methods of detection are performed using single-person pose. Although being able to distinguish “small” road users better than bottom-up methods, inference time is proportional to the number of people in the image, making it difficult to deploy on embedded systems. Furthermore, these methods are highly dependent on accuracy of the detector to achieve high precision.

Another research titled “CE-HigherHRNet: Enhancing Channel Information for Small People Bottom-Up Human Pose Estimation” by Li et al. describes Channel-Enhanced HigherHRNet (CE-HigherHRNet). The HigherHrnet comprises three main components: multiscale subpixel skip fusion module, lightweight attention mechanism (with channel attention enhanced and spatial attention modules), and a high-resolution feature pyramid. After each feature map fusion the lightweight attention mechanism optimizes the map.

All the approaches mentioned above group keypoints associated with body parts to predict the person's pose. Since the grouping function takes minimal computational time, the total inference time for bottom-up methods is usually independent of the number of people in the image. However, the performance of bottom-up methods drops significantly on “small” people. The whole image is used as input and therefore the resolution of “small” road person gets compromised.

Although the prior art involves many ADAS systems that could be used for real-time pose estimation of people, it is yet to be developed an all-encompassing system that does not compromise computational time with accuracy or vice-versa. Both faster processing and avoiding false detection is crucial for development of roadside person detection within driving environments.

Therefore, the present invention is designed to address the peculiar challenges in the prior art, the present invention discloses a system for real time detection the poses people around a vehicle. The system uses a new top-down approach for pose determination of people. The system described in the present invention merges a lightweight backbone infrastructure with a confidence pre-processing procedure method for faster and quicker detection of people's poses. In addition to faster detections, there is also provision for recalling any omitted detections or reduction of false detections associated with people overlapping each other in view or detected in proximity.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need to provide the system for predicting poses of vulnerable road users or people, which uses a lightweight backbone infrastructure with lesser complexity ensuring usage of images with higher resolutions for processing, thereby overcoming the drawbacks of the prior art involving “small” or “faraway” people and reduces false detections within the systems known in the art.

### SUMMARY OF THE INVENTION

In accordance with the present invention, the disadvantages and limitations of the prior art are substantially avoided by providing a novel lightweight person pose estimation method and system for detection of multiple people around a vehicle. The system, according to the present invention, uses a lightweight and less complex backbone for processing images of pedestrians. Images used can therefore be of larger sizes and higher resolution, providing case and accuracy in pose estimation related to vulnerable road users (VRU). The added benefit of deducing false or error prone detection and recovering missed detections of individual people using a road, makes the system preferable for ADAS, especially self-driven automobiles.

The present invention discloses an electronic device like a camera or video capturing device like a dash cam associated with a vehicle for generation of consecutive frames within a video. According to an alternate embodiment of the present invention the consecutive frames can be images generated by any image capturing device. The consecutive frames include a first frame and a number of subsequent frames. According to a preferred embodiment of the present invention, the first frame is used by a boundary box generator of a person detector that generates a boundary box around any of the people within the vicinity of the vehicle.

The people are present in the first frame as well as the subsequent frames. The boundary box is unique to each of the people identified in the first frame of the consecutive frames of the video. Any one of the consecutive frames in which any one of the people is first identified, then becomes the original frame for the one of the people and the consecutive frames following the original frame for the one of the people becomes the subsequent frames for the one of the people. According to a preferred embodiment of the present invention, the person tracker predicts the location of each person and places a boundary box within the subsequent frames using trackers. The trackers are associated with keypoints of pose or limbs of the people.

A person detector and tracker uses the boundary box generator and then compares trackers across a threshold number of consecutive frames to detect matches between one of the trackers and a boundary box of the current frame. According to a preferred embodiment of the present invention, the person detector and tracker includes a tracker match comparator and a tracker optimizer. The tracker match comparator determines the level of match of the boundary boxes and the trackers between each of the consecutive frames of the threshold number. The tracker optimizer uses processing methods to reduce false positives and recover false negative detections. According to a preferred embodiment of the present invention, the tracker optimizer ensures that mismatch between any one of the trackers is valid across the threshold number of the consecutive frames. If the tracker does not “match” within the threshold number, such keypoint i.e. one of the tracker is discarded from pose estimation, by the tracker optimizer.

However, if within the threshold number of the consecutive frames, the mismatched trackers matches with the detection of the boundary box again, the tracker is updated by the tracker optimizer into an updated tracker. Therefore, according to a system of detection of the people of the present invention, the updated trackers are all of the trackers that have successfully matched at the end of the tracking optimization.

According to a preferred embodiment of the present invention, the updated trackers of the subsequent frames are used as input by a pose estimator. The pose estimator comprises a backbone network to generate a feature map based on the updated tracker of the subsequent frames. The feature map can be used directly or by merging multiple resolution convolutions of the feature map using various deep learning CNN based approaches. According to a preferred embodiment of the present invention, the feature map is converted into a heat map for analysis by a keypoint encoder and decoder. According to a preferred embodiment of the present invention, the heat map is modulated by the keypoint encode and decoder for identification of underlying maximum values of keypoints. Maximum values are used for pose estimation by applying Taylor expansion by the keypoint encoder and decoder.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference similar features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 illustrates a system for detecting the poses of people around a vehicle in accordance with the present invention.

FIG. 2 illustrates the anatomy of person used in dataset pre-training in accordance with the present invention.

FIG. 3 illustrates the workflow of the confidence pre-processing procedure in accordance with the present invention.

FIG. 4 illustrates a backbone network in accordance with the present invention.

FIG. 5 illustrates a method for detecting the poses of people around a vehicle in accordance with the present invention.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phrascology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification comprises references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

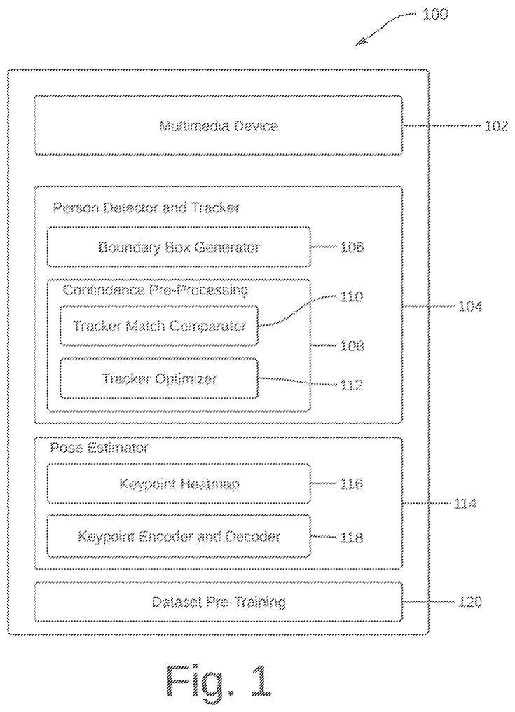

FIG. 1 illustrates a system for detecting the poses of people around a vehicle. System 100 is used in advanced driving assistance systems integrated with an autonomous or manually driven vehicle in order to detect pedestrians or other vulnerable people prone to collisions with vehicles. The detection of people therefore needs to be precise as well as quick for the system 100 to be used for safety purposes. The system 100 comprises a multimedia device 102 capable of capturing and providing to the system 100 a plurality of consecutive frames. The plurality of consecutive frames can be generated from a fraction of a video or multiple images being captured using any image capturing device such as a camera or integrated lens systems. According to a preferred embodiment of the present invention, the plurality of consecutive frames includes an original frame as a first frame and one or more new frames following the original frame.

Selecting one of the plurality of consecutive frames to be the original frame depends on whether any one of the people that is captured with the video was first detected within the one of the plurality of consecutive frames. According to a preferred embodiment of the present invention, a person detector and tracker 104 is present within the system 100 for tracking the people within the plurality of consecutive frames. The original frame is fed into a boundary box generator 106 that encloses each person detected by a boundary box.

The boundary box generator 106 and the boundary boxes created by it are used by the person detector and tracker 104 to distinguish between people within the original frame. According to a preferred embodiment, the boundary boxes created around the people by the boundary box generator 106 separate the people individually from the point-of-view of the multimedia device 102 capturing the video. According to a preferred embodiment of the present invention, a confidence pre-processing procedure 108 present within the person detector and tracker 104 uses mathematical modeling in order to track movement of the people of the original frame, into next frames i.e. the new frames and ensure the likelihood that each box is truly a person.

It should be appreciated that in the original frame, there may be multiple boundary boxes, one for each person detected. The original frame should have at least one boundary box and at least one tracker which corresponds to each boundary box. Also, each additional new frame will have a boundary box with the at least one corresponding tracker associated with each previously detected person. This will allow the system to detect position changes across the new frames.

The movement tracking of the people includes movement of limbs and/or body parts as part of the pose of the person. According to a preferred embodiment of the present invention, the confidence pre-processing procedure 108 predicts the inter-frame motion of each person within the new frames using a linear velocity model solved by Kalman Filter.

The trackers are generated by the confidence pre-processing procedure 108 related to any one of the boundary box i.e. any one of the people. According to a preferred embodiment of the present invention, associations of the boundary boxes and the trackers are optimized using Hungarian algorithm by the confidence pre-processing procedure 108. The confidence pre-processing procedure 108 comprises a tracker match comparator 110 and a tracker optimizer 112. According to a preferred embodiment of the present invention, the tracker match comparator 110 applies a Hungarian algorithm, also called the Kuhn-Munkres algorithm, as a matching algorithm that can be used to find maximum-weight matching in bipartite graph. According to the present invention, the trackers in any one of the new frames and next new frame will create two sets of “matched” or “unmatched” detections.

The trackers having “matched” detection and the “unmatched” detections are classified appropriately before taken for consideration by the tracker optimizer 112. According to a preferred embodiment of the present invention, the tracker optimizer evaluates both sub-sets of the trackers i.e. “matched” and “unmatched” based on pre-set criteria before converting the trackers into an updated tracker. The updated tracker is either one of the “matched” or “unmatched” detection that is determined to be valid detection after evaluation by the tracker optimizer 112.

All of the updated trackers and associated boundary boxes are used by a pose estimator 114 to generate a keypoint heatmap 116. According to a preferred embodiment of the present invention, the pose estimator 114 uses a top-down approach. The pose estimator 114 of the present invention uses high-resolution backbone network (HRnet), which is a conventional deep learning model that uses high resolution frames for input and as well as processing. The use of high resolution information ensures that the positional information is preserved well enough in the high-to-low and low-to-high process, which is essential for pose estimation tasks. Specifically, The pose estimator 114 employs a HRnet w18 backbone to output the heatmap using the updated trackers and the boundary boxes from the confidence pre-processing procedure 108 as input. HRnet w18 is a lightweight backbone network that is less complex and gives better performance than other models available such as hourglass and residual networks.

The keypoint heatmap map 116 generated by the pose estimator 114 is used by an keypoint encoder and decoder 118 for inference by the system 100. According to a preferred embodiment of the present invention, the keypoint encoder and decoder 118 encodes data of the feature map into any suitable 2D representation of positional information of the updated trackers in two axis formats. The 2D representation is used by the keypoint encoder and decoder 118 for detecting inter-frame position of body parts of the people depicted by maximum values of the keypoint heatmap 116. According to a preferred embodiment of the present invention, the keypoint encoder and decoder 118 uses distribution-aware keypoint representation to decode 2D representation, by modulating data of the 2-D representation under Gaussian distribution by applying Taylor expansion. According to a preferred embodiment of the present invention, accumulation of the data via the feature map is further calibrated using dataset pre-training 120 of the system 100. The dataset pre-training 120 comprises large public datasets that are used to train the pose estimator 114 and boost the performance on pose estimation datasets of the present invention.

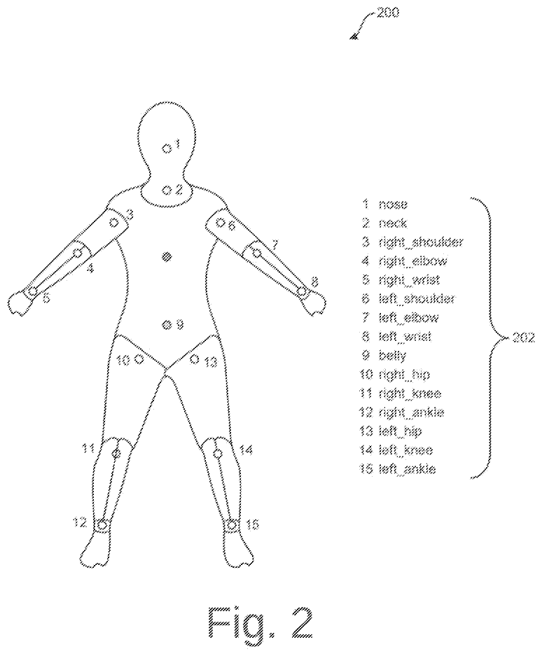

FIG. 2 illustrates the anatomy of person 200 used in dataset pre-training 120 detected by a system of the present invention. The person 200 represents any person detected around the vicinity of the vehicle with potential of being harmed. The vulnerability of person is detected by analysis of person 200 in real-time. Orientations of limbs or body parts 202 and their detection is important to provide safe driving in ADAS environments. It is imperative that the system, according to the present invention, detects each and every pedestrian on the road with precision and detail.

The crowds of the people are distinguished individually by surrounding each of the people with a boundary box. According to a preferred embodiment of the present invention, pose estimation of the people 200 comprises assigning pose points (1-15) to the body parts 202 of each person 200. These body parts serve as keypoints for pose tracking within a plurality of consecutive frames of a video generated by the system of the present invention. The video is real time capture of a scene around the vehicle that the people 200 are using.

The people 200 may include pedestrians, cyclists, motorcyclists, skaters, or other people commonly found around a road. According to a preferred embodiment of the present invention, each of the body parts (1-15) is associated with a keypoints. For example, a keypoint 8 is related to positions of the left wrist of the person 200. The position of keypoint 8 is traced in each of the one or new frames. Similar to keypoint 8, various other positions of the body parts (1-15) and related keypoints are shown in FIG. 2. for estimation of pose of pedestrians according to the system of the present invention.

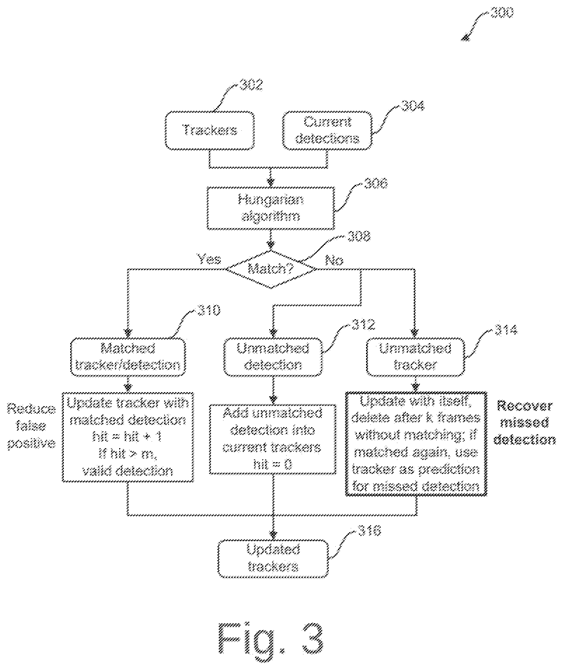

FIG. 3 illustrates the workflow of the confidence pre-processing procedure 300 in accordance with the present invention. The confidence pre-processing procedure 108 uses a video of a plurality of consecutive frames as input and estimates the movement of body-parts of people within the plurality of consecutive frames to determine pose of the people. According to a preferred embodiment of the present invention, confidence pre-processing procedure starts with enclosing any one of the people with a boundary box within an original frame of the plurality of consecutive frames using the boundary box generator 106. The plurality of consecutive frames comprises the original frame and new frames, respectively.

The original frame is a first frame in which the people are first detected. According to a preferred embodiment of the present invention, pose estimation proceeds by tagging trackers 302 related to the people across new frames using a mathematical model 306. Both the trackers 302 and the boundary box are sorted using a Simple Online and Realtime Tracking algorithm (SORT). The SORT algorithm applied by the confidence pre-processing procedure 300 uses tracking-by-detection method having two phases.

The first phase involves assigning the trackers 302 based on an estimation of locations where the people are deemed to be present in the next new frame based on the motion prediction solved by the Kalman filter. The second phase involves detecting keypoint data based on the trackers 302. According to a preferred embodiment of the present invention, a current detection 304 is made within each of the new frames related to the trackers 302. The second phase involves matching the trackers to the bounding boxes generated by the person detector and tracker 104 in the new frame.

The mathematical model 306 is used for predicting the trackers by a confidence pre-processing procedure of the confidence pre-processing procedure 300 as well as detecting positive and negative matches between the trackers 302 and the current detection 304. According to a preferred embodiment of the present invention, matching levels are detected by the mathematical model 306, such as a Hungarian algorithm. After application of a Hungarian algorithm to a video feed comprising the trackers 302 and the current detection 304, pairs of tracker and detections are created. These detections are segregated by a tracker optimizer 308 based on a matched detection 310 and unmatched detections. According to a preferred embodiment, the matched detection 310 is that detection in which any one of the trackers 302 and the current detection is superimposed on a predicted locus.

In order to reduce false positive detections, according to a preferred embodiment of the present invention, the matched detection 310 is further evaluated based on repetitiveness of the matched detection 310 over a defined number M of the new frames. The defined number M of the new frames is a minimum number of frames with matched detection 310 positively detected for matching. Therefore, according to the preferred embodiment of the present invention, if a number of matching hits is ≥M, then the matched detection 310 is considered to be a valid detection. The system of pose estimation of the people involves the recalling of all unmatched detections after application of the mathematical model 306.

An unmatched detection can be of two types: an unmatched detection 312 and an unmatched tracker 314. An unmatched detection 312 occurs when there is a new detection and the number of matching hits with trackers is zero. An unmatched tracker 314 occurs when there are trackers 302 that do not “match” with the current detection 304. According to a preferred embodiment of the present invention, the means for retrieval of a missed detection is provided at this step, involving a threshold number of frames K of the new frames. When the system of the present invention detects the unmatched tracker 314, the threshold number of frames K of the new frames are traced for any potential “match”.

According to a preferred embodiment of the present invention, if the detections match again with respect to the unmatched tracker 314 previously detected within the threshold number of frames K of the new frames, the tracker optimizer 308 updates the unmatched tracker 314 into a valid detection. In contrast, if the tracker optimizer 308 receives the unmatched tracker 314 that fails to match with the missed detection within the threshold number of frames K, the tracker optimizer 308 flags the unmatched tracker 314 from the confidence pre-processing procedure 300. The trackers 302 and the current detection 304 evaluated to be valid detections by the tracker optimizer 308 are updated and the more trackers associated with valid detections are converted into an updated tracker 316. The updated tracker 316 is used further by the system of the present invention for estimation of poses. A heatmap incorporating the updated tracker 316 is generated by a pose estimator. The pose estimator comprises conventional deep learning models for processing data from the tracker optimizer 308.

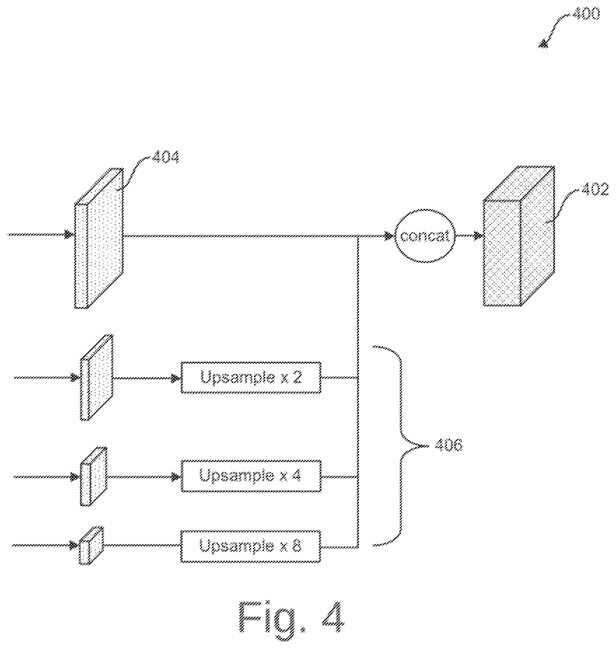

The pose estimator necessitates quick processing to timely determine vulnerable pedestrians, collision avoidance, and safe driving. A top-down approach adopted by a system 400 of FIG. 4 is preferable in case of “small” or far-away pedestrians of the pose estimator, as shown in FIG. 4. The backbone network 400 converts position related data of the updated tracker provided by a person tracker into a feature map 402. The updated tracker comprises frame-related information, particularly based on new frames of a video generated by a multimedia device of a vehicle and, hence, image resolution becomes important.

According to a preferred embodiment of the present invention, the backbone network 400 uses a HRnet model that maintains high-resolution representation 404 of the new frames and the updated tracker associated with each of the new trackers throughout the whole process by constructing parallel convolutions 406 of different resolutions and repeatedly exchanging information across the convolutions 406. According to an alternate embodiment of the present invention, the backbone network 400 uses the high-resolution representation 404 directly to generate the feature map 402. Conventional deep learning models typically “learn” by up-sampling or de-convolution of low-resolution representations of any one of the new frames and then reconstruct high dimension output i.e. the feature map 402.

Positional information may not be preserved well and loss of data is seen in both the high-to-low and low-to-high process. This becomes a serious limitation for pose estimation tasks. According to a preferred embodiment of the present invention, the convolutions 406 or high-resolution representation 404 are used by the backbone network 400 using a HRnet model, particularly a HRnet w18 backbone.

According to an alternate embodiment of the present invention, other HRnet models, such as HRnet w32 backbone with similar processing capabilities (1.8 GFLOPs), can also be used as the backbone network 400. The HRnet w18 backbone maintains high resolution across the convolutions 406 avoiding loss of positional data during generation of the feature map 402. In addition, the HRnet w18 backbone is lightweight and occupies fewer computing resources against other deep learning approaches known in the art, such as hourglass networks and Resnet.

According to a preferred embodiment of the present invention, a lightweight backbone is especially important for the pose estimator when the new images contain positional data related to several pedestrians simultaneously. Since the HRnet w18 backbone of the present invention uses less computing resources, detection of the people within a crowd at a roadway becomes faster and more efficient. For that reason, the HRnet w18 backbone is preferred over the HRnet w32 backbone variant. For example, the HRnet w18 backbone is lightweight and images up to 256×192 in size can be fed into the backbone network 400 for processing, while images up to 128×96 in size can be fed the HRnet w32 backbone. The use of larger images as input reduces false detections where resolution hinders proper person detection of “far-away” pedestrians. According to a preferred embodiment of the present invention the backbone network 400 concatenates the convolutions 406 in order to form the feature map 402.

| | | | AP on COCO 2017 val |
|---|---|---|---|
| | Input size | GFLOPs | dataset |
| HRnet w18 | 256 × 192 | 1.2 | 0.679 |
| HRnet w32 | 128 × 96 | 1.8 | 0.669 |

The final output of a keypoint position is determined by extracting the maximal value of the keypoint heatmap generated by the HRnet backbone. The generation of a feature map and tracker based on mathematical and AI approaches are essential to pose estimation of the people. A dataset pre-training is present in the system that continuously fine-tunes the pose estimator.

According to a preferred embodiment of the present invention, the dataset pre-training uses large public datasets and self-collected datasets by the system to train the backbone network and confidence pre-processing procedure to improve detection of the people. Public datasets that can be used by the system of the present invention comprise, for example: COCO, CrowdPose and Imagenet. According to an embodiment of the present invention, the dataset pre-training may use any large public dataset having a different number of keypoints. As shown in FIG. 2, the system according to the present invention uses 15 keypoints i.e. trackers related to the body parts (1-15). The dataset pre-training can use a public dataset like COCO despite using 17 keypoints against 15 keypoints of the present invention. To mimic the pedestrians in ADAS applications, the images in public datasets are resized to smaller sizes so that scales are closer to the people.

| | | | AP on | AP on |
|---|---|---|---|---|
| | | | pedestrian | pedestrian val |
| | | | val | dataset (Adas |
| | | | dataset | detection |
| Model | Pretrain | Train Data | (GT boxes) | boxes) |
| HRnet w18 | ImageNet | BST pedestrian | 0.679 | 0.477 |
| HRnet w18 | COCO 2017 | BST pedestrian | 0.697 | 0.496 |

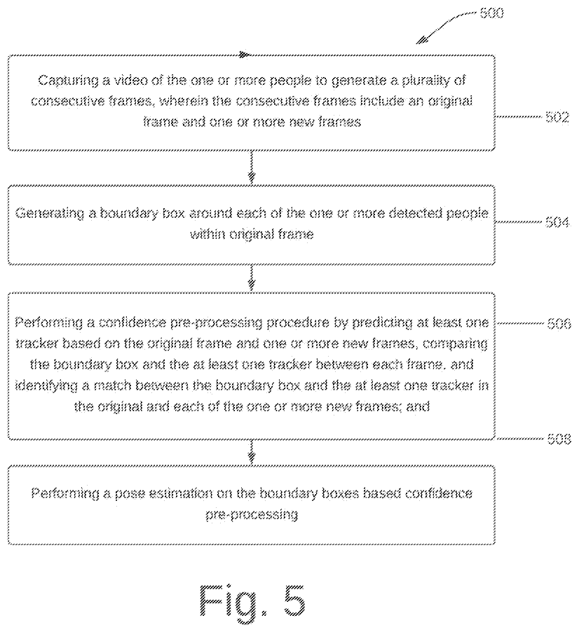

FIG. 5 illustrates a method (500) for detecting multiple people on a roadway. The method comprises a step (502) of capturing a video of the multiple people on the road to generate a number of consecutive frames. The number of consecutive frames comprises an original frame and new frames. The video is captured by any electronic device and similar devices. The electronic devices are any video or image capturing device. The electronic device is any camera, video camera, dash cam, or any driving system integrated camera. The people include any vulnerable person using the road including pedestrians, cyclists, runners, or skaters. The road comprises any area for driving vehicles, including highways or local roads.

Further, the method 500 comprises capturing a video of the one or more people to generate a plurality of consecutive frames, wherein the consecutive frames include an original from and one or more new frames 502 and generating a boundary box around each of the people within the original frame 504. Further, the method 500 comprises a step of performing a confidence pre-processing procedure by detecting matches of one or more trackers between each the of the one or more new frames 506. The confidence pre-processing procedure includes predicting movement of the people by updating tracker locations in the new frames using a mathematical model. The mathematical model is a linear velocity model using Kalman filtering. Additionally, the confidence pre-processing procedure matches any one of the trackers with the detected boundary boxes for each of the new frames and evaluates a threshold number of the new frames to determine valid matching between any one of the trackers and detection of boundary boxes across the threshold number. Any of the trackers if not positively matched within the threshold number of frames is discarded. Further, confidence pre-processing procedure 506 optimizes each of the trackers into an updated tracker based on detection by the match detector. The tracker optimizer updates unmatched trackers into a matched tracker if matching occurs within the threshold number of frames.

Further, the method 500 comprises performing a pose estimation on the boundary boxes based on the confidence pre-processing 508 including generating a keypoint heatmap. A feature map of pose related information from each of the updated tracker and the boundary boxes using deep learning approaches. The method uses the output from the highest resolution branch of HRnet model as the feature map to regress the keypoint heatmap. The feature map is constructed by concatenating parallel multi-resolution convolutions of the feature map or by directly using the highest resolution sample of the feature map. The deep learning approaches use convolutional neural network (CNN) based methods for generating the feature map. The HRnet backbone model comprises a HRnet w18 backbone or a HRnet w32 backbone to construct the feature map. The feature map comprises image input size of 256×92 and 128×96, respectively.

Further, the pose estimation 508 includes encoding the feature map into a 2D representation and decoding maximum values of the 2D representation using statistical methods. The method 500 may include pre-training the pose estimator on large public datasets and calibrates each of the feature maps for pose estimation of the people on the roadway.

It should be appreciated that the terms “a person detector and tracker”, “boundary box generator”, “confidence pre-processing procedure”, “a tracker optimizer”, and “pose estimator” may be implemented all or in part by software, hardware or a combination thereof. They may be embedded in or independent of the processor in the electronic device in the form of hardware, or may be stored in the memory of the electronic device in the form of software, so that the processor can invoke the software to execute the operations required.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A system for detecting people, comprising:
an electronic sensor, wherein the electronic sensor captures a video of people around a vehicle to generate a plurality of consecutive frames, and wherein the plurality of consecutive frames comprises an original frame and one or more new frames;
a person detector and tracker, comprising a boundary box generator that detects an enclosed boundary box within the original frame and one or more new frames, and a confidence pre-processing procedure for predicting locations of each person identified using a mathematical model;
wherein the confidence pre-processing procedure includes a tracker match comparator which predicts at least one tracker based on the original frame and one or more new frames, compares the boundary box and the at least one tracker between each frame, and identifies a match between the boundary box and the at least one tracker in the original and each of the one or more new frames;
a tracker optimizer for optimizing the at least one tracker into an updated tracker based on detection by the tracker match comparator; and
a pose estimator, comprising a backbone network for constructing a feature map of pose related information from the updated tracker and the boundary box using deep learning approaches, and a keypoint encode and decoder for encoding at least one keypoint location into a 2-D representation and decoding maximum values of the 2-D representation using statistical methods.

2. The system of claim 1, further including a dataset pre-training, wherein the dataset pre-training trains the pose estimator on at least one large public dataset and calibrates an initial weight for pose estimation of each person identified.

3. The system of claim 1, wherein the electronic sensor is a camera that captures video or images.

4. The system of claim 1, wherein tracker optimizer updates a matched tracker for each match found in the one or more new frames.

5. The system of claim 4, wherein the matched tracker is sent to the pose estimator after meeting a threshold N number of matches.

6. The system of claim 1, wherein tracker optimizer converts a previously unmatched tracker to a matched tracker.

7. The system of claim 1, wherein the tracker optimizer updates the previously unmatched tracker for each match not found in the one or more new frames.

8. The system of claim 7, wherein the previously unmatched tracker is deleted after meeting a threshold K number of frames without a match.

9. The system of claim 1, wherein the confidence pre-processing procedure sorts the at least one tracker and the boundary box of each frame using a Simple Online and Realtime Tracking algorithm (SORT).

10. The system of claim 7, wherein the SORT uses the boundary box of each frame created by the boundary box generator as an input.

11. The system of claim 1, wherein the confidence pre-processing procedure predicts the inter-frame motion of the person with a linear velocity model solved by Kalman Filter.

12. The system of claim 1, wherein the backbone network uses a HRnet w18 backbone or a HRnet w32 backbone.

13. The system of claim 1, wherein the feature map is constructed by concatenating parallel multi-resolution convolutions of the feature map or by directly using the highest resolution sample of the feature map.

14. The system of claim 13, wherein the feature map comprises an image input size of at least 128×96.

15. The system claim 1, wherein the large public datasets includes at least one Common Objects in Context (COCO), Imagenet, or CrowdPose dataset.

16. A method for detecting people, comprising:
capturing a video of the one or more people to generate a plurality of consecutive frames, wherein the consecutive frames include an original frame and one or more new frames;
generating a boundary box around each of the one or more detected people within the original frame and one or more new frames;
performing a confidence pre-processing procedure by predicting at least one tracker based on the original frame and one or more new frames, comparing the boundary box and the at least one tracker between each frame, and identifying a match between the boundary box and the at least one tracker in the original and each of the one or more new frames; and
performing a pose estimation on the boundary boxes based on the confidence pre-processing;

17. The method of claim 16, further including updating a matched tracker for each match found in the one or more new frames and sending the matched tracker to a pose estimator after meeting a threshold N number of matches.

18. The method of claim 16, further including converting a previously unmatched tracker to a matched tracker.

19. The method of claim 16, further including updating an unmatched tracker for each match not found in the one or more new frames and deleting the unmatched tracker after meeting a threshold K number of frames without a match.

20. The method of claim 16, further including pre-training a pose estimator on at least one large public dataset and calibrating an initial weight for pose estimation of each person identified.
